(19) United States
(12) Patent Application Publication
(10) Pub. No.: US 2005/0216940 A1
(43) Pub. Date: Sep. 29, 2005

(54) Method and system which enables subscribers to select videos from websites for on-demand delivery to subscriber televisions via cable television network

(75) Inventor: Neville A. Black, Collegeville, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/809,729

(22) Filed: Mar. 25, 2004

(51) Int. Cl. H04N 7/173; G06F 13/00; H04N 7/20; H04N 7/16

(52) U.S. Cl. 725/87; 725/104; 725/61; 725/4

(57) ABSTRACT

A video-on-demand (VOD) method and system for use with a computer connected to the Internet includes an Internet website. The website lists videos available for delivery from a content provider to a cable provider subscriber. The subscriber uses the computer to select a video from the website. The cable provider receives the selected video from the content provider and then delivers the video to a television of the subscriber via the cable television network. The subscriber uses the computer to register an interest profile on the website. Information regarding the available videos is compared with the profile and an email is then sent to the subscriber via the Internet. The email contains information regarding the available videos corresponding to the profile. The subscriber requests a video identified in the email for delivery from the content provider to the television via the cable television network.

### BACKGROUND OF THE INVENTION

1. Field of the Invention

The present invention generally relates to video-on-demand (VOD) methods and systems and, more particularly, to a method and system which enables subscribers of a cable television service provider to select videos listed on third party content provider websites using personal computers connected to the Internet for on-demand delivery of the selected videos from the third party content providers to subscriber televisions via a cable television network.

2. Background Art

Cable television networks enable a cable television service provider to distribute videos “on-demand” to subscriber televisions for subscribers (i.e., viewers, users, etc.) to view in response to subscriber requests for the videos. This video distribution service is referred to as “video-on-demand” (VOD). In operation, a subscriber of the cable television service provider sends a request for a video over the cable television network to the cable provider. The cable provider then delivers the requested video over the cable television network to the subscriber's television for the subscriber to view.

The subscriber's television has a cable television network transceiver such as a set-top-box (STB) or the like which connects the subscriber's television to the cable television network. The STB is operational with the cable provider to display a graphical user interface (GUI) such as a television electronic program guide (EPG) on the subscriber's television. The EPG lists videos available to the subscriber from the cable provider. To order a video from the cable provider, the subscriber uses a television remote control or the like to select an EPG entry corresponding to a requested video. The STB then transmits a video request corresponding to the requested video over the cable television network to the cable provider. In response, the cable provider delivers the requested video over the cable television network for receipt by the STB of the subscriber's television. The STB then provides the video on the subscriber's television for the subscriber to view.

An advantage of distributing videos on cable television networks is that subscribers watch videos on televisions instead of watching videos on other display devices such as personal computers. Subscriber televisions are commonly state of the art viewing devices such as plasma televisions, wide-screen televisions, televisions having surround sound speakers, “high definition” televisions, etc., which are placed at optimum viewing locations such as in front of a sofa in a family room, etc. As such, the subscriber's viewing experience when viewing videos on televisions is typically much better than the subscriber's viewing experience when viewing videos on personal computers.

A disadvantage of selecting videos from a cable television service provider is that the cable provider typically has a limited number of videos available for delivery to the subscribers. Another disadvantage of selecting videos from a cable television service provider is that it is difficult to enable the subscriber to perform browsing and searching functions on EPGs displayed on the subscriber's television. Browsing and searching Internet websites using personal computers connected to the Internet are much easier for users such as subscribers of the cable provider to perform.

The Internet enables various third party content providers to distribute videos to personal computers for viewers to view on their personal computers in response to viewer requests for the videos. In this case, the content providers have Internet websites for the viewers to access using personal computers connected to the Internet. The personal computers have web browsers configured to access, browse, and search the content provider websites via the Internet. The content provider websites list videos available from the content providers for the viewers. A viewer may select a video from a content provider's website. In turn, the content provider transmits the selected video to the viewer's personal computer via the Internet. The viewer then views the video on the personal computer.

An advantage of Internet video distribution systems is that the content providers, taken together as a whole, have an enormous number of videos of all kinds of content which are available for delivery to the viewers. Another advantage of Internet video distribution systems is that browsing and searching functions are much better and easier using personal computers connected to the Internet than on televisions connected to a cable television network.

A disadvantage of Internet video distribution systems is that content providers deliver the videos to personal computers via the Internet for the viewers to view on the personal computers instead of delivering the videos to the viewers' televisions. As such, viewers watch the videos on personal computers instead of watching the videos on televisions.

Another disadvantage of Internet video distribution systems is that personal computers located in the residences and homes of viewers are typically connected to the Internet using dial-up modems, cable modems, or digital subscriber line (DSL) technologies. Such communication technologies provide lower effective bandwidth for transmitting videos to personal computers over the Internet than the bandwidth provided by a cable television network to transmit the videos to subscriber televisions.

### SUMMARY OF THE INVENTION

Accordingly, it is an object of the present invention to provide a method and system for “on-demand” delivery of selected videos in which the method and system have the above-noted advantages of cable television and Internet video distribution systems while not having any of the above-noted disadvantages of cable television and Internet video distribution systems.

It is another object of the present invention to provide a method and system which enables subscribers of a cable television service provider to select videos listed on third party content provider Internet websites using personal computers connected to the Internet for on-demand delivery of the selected videos from the content providers to subscriber televisions via a cable television network.

It is a further object of the present invention to provide a method and system which enables subscribers of a cable television service provider to register video interest profiles with entities or Internet websites and then receive emails containing information regarding videos which correspond to the video interest profiles and which are available from third party content providers for on-demand delivery to televisions of the subscribers via a cable television network.

In carrying out the above objects and other objects, the present invention provides a VOD system and an associated method for use with personal computers connected to the Internet. The system includes a cable television network and further includes content provider Internet websites. The content provider websites list videos available for delivery from third party content providers to subscribers (i.e., users, viewers, etc.) of a cable television service provider. The content providers are third party content providers in the sense that they are independent entities with respect to the cable television service provider. The subscribers use the computers to select, via the Internet, videos from the content provider websites for delivery from the content providers to the subscribers. The system further includes televisions associated with the subscribers and connected to the cable provider via the cable television network. The content providers and the cable provider are in communication with one another in order for the cable provider to receive the selected videos from the content providers. The cable provider delivers the selected videos to the televisions via the cable television network for the subscribers to view on the televisions.

The cable provider may deliver the selected videos by streaming the selected videos to the televisions via the cable television network immediately after the subscribers have selected the videos. The cable provider may store the selected videos on a video server for subsequent delivery from the video server to the televisions via the cable television network. The cable provider may also deliver the selected videos to video recorders associated with the televisions via the cable television network for the subscribers to subsequently view on the televisions.

The subscribers may perform key word searches using the computers in order to select videos from the content provider websites for delivery from the content providers to the subscribers. The subscribers may have associated identification identifying the subscribers. In this case, the content providers may provide the identification along with the selected videos to the cable provider. In turn, the cable provider uses the identification in order to deliver the selected videos to the televisions via the cable television network.

The selected videos may have descriptive information identifying the selected videos. In this case, the content providers may provide the descriptive information along with the selected videos to the cable provider for use by the cable provider. The cable provider may bill the subscribers for the selected videos on behalf of the content providers. The subscribers may have subscriptions with the cable provider to select videos from the content provider websites for delivery to the subscribers. In this case, the cable television service provider may bill the subscribers for the subscriptions. The personal computers and the televisions are remote from one another and are in indirect communication with one another via the Internet and the cable television network.

The system may further include a cable provider Internet website. In this case, the subscribers may use the computers to register video interest profiles on the cable provider website. In turn, the content providers communicate information to the cable provider regarding videos available for delivery from the content providers to the subscribers. The cable provider compares the information regarding the videos with the video interest profiles of the subscribers and then sends emails to the subscribers. The emails contain information regarding the videos corresponding to the video interest profiles of the subscribers.

Also, in carrying out the above objects and other objects, the present invention provides a VOD method and an associated system for use with a personal computer connected to the Internet, and for use with a television associated with a subscriber of a cable television service provider and connected to the cable television service provider via a cable television network. The method includes providing a content provider Internet website listing videos available for delivery from a third party content provider to a subscriber of the cable provider. The subscriber uses the computer to select a video from the content provider website for delivery to the subscriber. The method further includes communicating the selected video from the content provider to the cable provider. The method also includes delivering the selected video from the cable provider to the television via the cable television network for the subscriber to view on the television.

Further, in carrying out the above objects and other objects, the present invention provides another VOD system and an associated method for use with a personal computer connected to the Internet. This system includes a cable television service provider having a cable television network connected to a television of a subscriber. The subscriber uses the computer to register a video interest profile on an Internet website. A third party content provider communicates information to the cable provider regarding videos available for delivery from the content provider to the television of the subscriber via the cable television network. At least one of the cable provider and the content provider compares the information regarding the videos with the video interest profile of the subscriber and then sends an email to the subscriber via the Internet. The email contains information regarding the videos corresponding to the video interest profile of the subscriber.

The subscriber may then use the computer to transmit a request to at least one of the cable provider and the content provider via the Internet for a video identified in the email to be delivered to the television of the subscriber. In response to the request, the cable provider receives the requested video from the content provider and then delivers the requested video to the television via the cable television network for the subscriber to view on the television.

The content provider may also have an Internet website which lists videos available for delivery from the content provider to the subscriber. In this case, the subscriber uses the computer to select a video from the content provider website for delivery from the content provider to the subscriber. The cable provider receives the selected video from the content provider and then delivers the selected video to the television via the cable television network for the subscriber to view on the television.

### BRIEF DESCRIPTION OF THE DRAWINGS

FIG. 1 illustrates a block diagram of a video-on-demand (VOD) system in accordance with the present invention; and

FIG. 2 illustrates a block diagram of a VOD system in accordance with an alternative embodiment of the present invention.

### DETAILED DESCRIPTION OF THE PREFERRED EMBODIMENT(S)

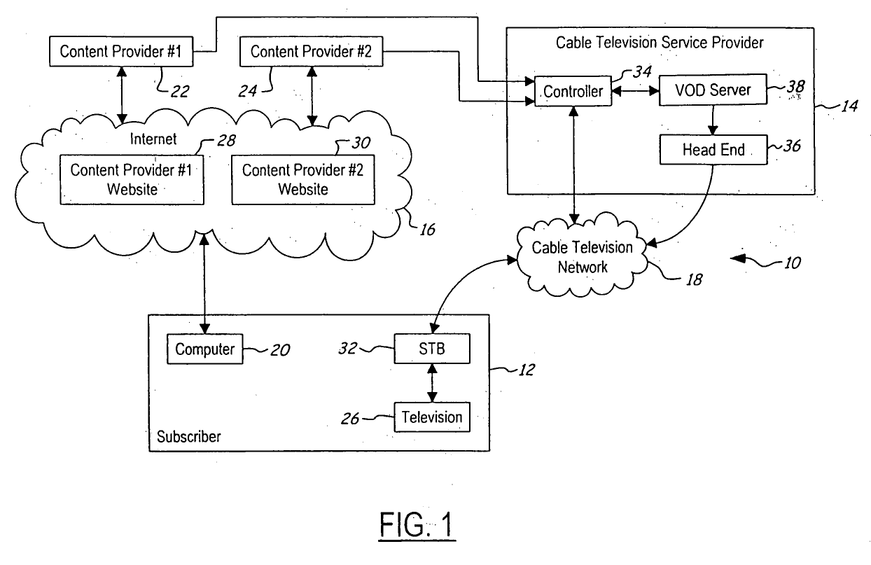

Referring now to FIG. 1, a block diagram of a video-on-demand (VOD) system 10 in accordance with the present invention is shown. VOD system 10 includes two communications networks for use with communicating to subscribers (e.g., viewers, users, etc.) such as a subscriber 12 of a cable television service provider 14. One communications network is the Internet 16 and the other communications network is a cable television network 18. Internet 16 generally connects a personal computer 20 of subscriber 12 to third party video content providers such as video content providers 22 and 24. Content providers 22 and 24 are third party content providers in the sense that they are independent entities with respect to cable television service provider 14. Cable television network 18 generally connects a television 26 of subscriber 12 to cable television service provider 14. In general, VOD system 10 enables subscriber 12 to select a video from one of content providers 22 and 24 using Internet 16 and computer 20 and then delivers the selected video from the content provider to cable provider 14 for delivery to television 26 of the subscriber via cable television network 18.

Personal computer 20 and television 26 may be located in the same general vicinity such as at the residence or household of subscriber 12. In this case, computer 20 is typically connected to Internet 16 using dial-up modem, cable modem, or digital subscriber line communications technologies. Computer 20 and television 26 may also be located remotely from one another. For example, computer 20 may be located in a school, library, office, etc., whereas television 26 is located in the residence or household of subscriber 12. In either case, computer 20 and television 26 are generally not in direct communication with one another. That is, no direct connection is required between computer 20 and television 26 in order for VOD system 10 to function in accordance with the present invention.

Personal computer 20 has a web browser which enables subscriber 12 to browse and search Internet websites via Internet 16. Subscriber 12 may enter “key words” in computer 20 in order to browse and search the Internet websites. Different content providers 22 and 24 have their own content provider Internet websites 28 and 30. Content provider websites 28 and 30 lists videos which are available by content providers 22 and 24 for delivery to subscriber 12. Subscriber 12 uses computer 20 to browse and search content provider websites 28 and 30 in order to select videos available for delivery to the subscriber from content providers 22 and 24. In this way, Internet 16 connects subscriber 12 to content providers 22 and 24.

Television 26 is associated with a respective communications network transceiver such as a set-top-box (STB) 32 or the like. STB 32 connects television 26 to cable television network 18. Cable television network 18, which is typically a hybrid fiber coax (HFC) network, enables two-way communications between cable provider 14 and subscriber 12 in order to provide the subscriber with VOD services. For VOD operation, subscriber 12 transmits a request for a video over cable television network 18 to cable provider 14. In response to this request, cable provider 14 transmits the requested video over cable television network 18 to subscriber 12 for the subscriber to view on television 26.

Cable provider 14 includes a controller 34, a head end 36, and a video server 38. Controller 34 connects to cable television network 18 in order to enable cable provider 14 to communicate with subscriber 12 and control the programming provided by the cable provider to the subscriber. Video server 38 connects to cable television network 18 via head end 36 in order to deliver videos from cable provider 14 over the cable television network to television 26 of subscriber 12 for the subscriber to view.

Cable provider 14 is in communication with content providers 22 and 24 in order to receive videos from the content providers for delivery to television 26 of subscriber 12 via cable television network 18. Cable provider 14 and content providers 22 and 24 may be connected to one another by private networks such as virtual private networks (VPN) and the like. In operation, subscriber 12 uses computer 20 to access a content provider Internet website such as website 28 of content provider 22. Subscriber 12 has an account number or the like which identifies the subscriber and/or STB 32 of television 26 of the subscriber. Subscriber 12 then selects a video from content provider website 28 by transmitting a request from computer 20 to content provider 22 via Internet 16. In turn, content provider 22 transmits the following to controller 34 of cable provider 14 over the private network: 1) a copy of the selected video; 2) the account number identifying subscriber 12 and/or STB 32; and 3) basic information identifying the video such as the title of the selected video.

Cable provider 14 uses the account number to identify subscriber 12 and the identity and location of STB 32 of the subscriber. Cable provider 14 then generally transmits the selected video to STB 32 of subscriber 12 via cable television network 18 for the subscriber to view on television 26. The mode of delivery of the selected video from cable provider 14 to subscriber 12 may vary. For example, for immediate viewing of a selected video, cable provider 14 streams the selected video via VOD server 38 and head end 36 over cable television network 18 for receipt by STB 32. In this case, the selected video is displayed on television 26 as cable provider 14 delivers the selected video over cable television network 18 to STB 32 immediately after subscriber 12 has selected the selected video from content provider website 28.

For subsequent viewing of a selected video, STB 32 may have storage such as a digital video recorder (DVR) or the like. In this case, cable provider 14 may deliver the selected video at opportune transmission times over cable television network 18 to STB 32. The DVR of STB 32 stores the selected video as the selected video is transmitted to the STB. Subscriber 12 may then view the selected video on television 26 at a later time. At the later time, STB 32 streams the selected video stored on the DVR to television 26 for subscriber 12 to view.

Alternatively, if STB 32 does not have storage for storing the selected video or if it is otherwise desirable to do so, cable provider 14 stores the selected video in VOD server 38. Head end 36 then communicates with STB 32 via cable television network 18 to display an EPG on television 26 advising subscriber 12 that the selected video is available for the subscriber to view. Head end 36 may cause an EPG having the basic information identifying the selected video to be displayed on television 26 for subscriber 12 to view. The EPG may display a subscriber folder or menu which lists the previously selected videos. Subscriber 12 may then communicate a request to controller 34 via cable television network 18, by highlighting an appropriate entry in the folder or menu of the EPG, advising cable provider 14 that the subscriber wants to view the selected video. In response to the request, controller 34 instructs VOD server 38 to stream the selected video over cable television network 18 to STB 32 for subscriber 12 to view on television 26.

In the case of the DVR of STB 32 storing the selected video, the STB may also be configured to display the customized subscriber EPG. In this case, subscriber 12 communicates a request to STB 32 by highlighting an appropriate entry in the folder or the menu of this EPG. In turn, STB 32 streams the selected video stored on the DVR to television 26 for subscriber 12 to view.

An advantage of the present invention is that third party content providers 22 and 24 have much more content available to subscriber 12 than the amount of content available to the subscriber from cable provider 14. For instance, in typical VOD methods and systems, cable provider 14 has a certain number of videos which can be delivered directly from the cable provider to subscriber 12. Such videos are typically current movies which have been recently shown at cinemas or television shows recently broadcast. With the present invention, a much greater and expansive amount of videos from content providers 22 and 24 are available to subscriber 12 for viewing on television 26.

For example, third party content providers 22 and 24 may have videos of older movies, less popular movies, foreign language movies, movies of interest to a small minority of the population, etc. Content providers 22 and 24 may have videos of other viewing interests other than movies. For example, content providers 22 and 24 may have videos of sports games such as the 1984 World Series; videos of non-broadcasted sports games; videos of seminars; “how to” videos; videos of classic television programs; videos of music bands; videos of historical news events; etc. Further, content providers 22 and 24 may be any of the following: schools, colleges, and universities having videos for prospective students to view; political groups having videos for members to view; public service groups such as the American Red Cross® having videos for donors to view; retailers and suppliers having videos for consumers to view; tourism groups having videos for tourists to view; etc. As such, content providers 22 and 24 have videos of a universe of different items with most videos typically being of interest to only a small percentage of the viewing audience at one time. Accordingly, subscriber 12 has an enormous amount of content to choose from for viewing on television 26 as a result of the present invention partnering the capabilities of Internet 16 with cable television network 14. Thus, the “library” of typical VOD systems is greatly increased in size with use of the present invention.

Furthermore, as noted above, subscriber 12 views the videos of content providers 22 and 24 on television 26 instead of viewing these videos on computer 20. This affords subscriber 12 a much better viewing experience. Additionally, subscriber 12 does not need a high bandwidth Internet connection to download selected videos from content providers 22 and 24 via Internet 16 as cable television network 18 delivers the selected videos to STB 32 for the subscriber to view on television 26.

Additionally, subscriber 12 is able to perform much better browsing and searching functions using computer 20 in order to select a video from content providers 22 and 24. As noted above, such browsing and searching functions are difficult to perform using television 26 and STB 32. Cable provider 14 may also have an Internet website for subscriber 12 to access via computer 20. The website of cable provider 14 may also feature the websites 28 and 30 of content providers 22 and 24.

Cable provider 14 may also handle the billing of subscriber 12 on behalf of content providers 22 and 24. Typically, content providers 22 and 24 require a fee from subscriber 12 to obtain a video from the content providers. Such fees are typically relatively small while the amount of transactions between one content provider and many subscribers may be relatively large. Accordingly, it is burdensome for the content provider to charge many subscribers a small fee. Further, the subscribers would likely pay such fees using credit cards of credit card providers. The credit card providers would add a service charge to handle such transactions with such service charge likely being at least a large percentage of the fee itself. As such, cable provider 14 may simply add the fee for the content provider to subscriber's cable television bill. In turn, subscriber 12 need only pay one bill. This greatly simplifies the amount of transactions and makes the costs efficient as the credit card provider is not needed to handle individual fees for videos provided by the content provider.

Additionally, cable television network 18 is now effectively open to many different content providers for the content providers to reach responsive viewing audiences. As such, cable provider 14 can partner with content providers 22 and 24 in order to provide subscriber 12 with a subscription to one, a subset, or all of the partnered content providers. In turn, subscriber 12 can select a given number (or any amount) of videos from content providers 22 and 24 on some sort of periodic (e.g., daily, weekly, monthly, etc.) fee basis. Subscriber 12 pays the periodic subscription fee to cable provider 14 which then pays content providers 22 and 24 according to their partnership agreements.

Furthermore, as noted above, computer 20 and television 26 may be located remotely from one another. For example, computer 20 may be located in a public facility such as a library and television 26 may be located in the home of subscriber 12. As such, subscriber 12 need not even own computer 20 in order to select a video from content providers 22 and 24 for delivery to the subscriber via cable television network 18. A practical application of this feature is that a school teacher could use a personal computer 20 connected to Internet 16 to order videos from content providers 22 and 24 for delivery over cable television network 18 to the households of students. Further, computer 20 and television 26 do not communicate directly with one another in order for use of the present invention.

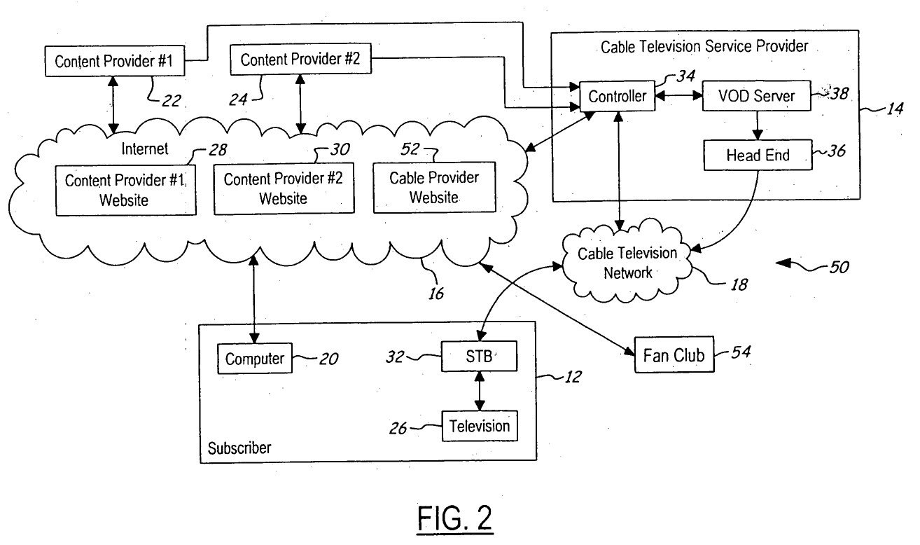

Referring now to FIG. 2, a block diagram of a VOD system 50 in accordance with an alternative embodiment of the present invention is shown. VOD system 50 includes the same elements as VOD system 10 and like elements have the same reference numerals. VOD system 50 generally differs from VOD system 10 by further including an Internet website 52 of cable television service provider 14. In general, VOD system 50 enables subscriber 12 to use computer 20 in order to register a video interest profile on cable provider website 52. In turn, cable provider 14 sends promotional emails regarding forthcoming videos from content providers 22 and 24 to subscriber 12 which correspond to the video interest profile of the subscriber. As such, VOD system 50 provides subscriber-targeted VOD recommendations.

In operation, subscriber 12 (and household members) uses computer 20 to register a profile of interest on cable provider website 52. For movie videos, the interest profile could include favorite actors, favorite directors, favorite genres. For non-theatrical videos, the interest profile could include various subject matter keywords. Content providers 22 and 24 periodically provide announcements to cable provider 14 over the electronic communication line connecting the content providers and the cable provider. The announcements regard video content forthcoming from content providers 22 and 24. The announcements include information for the forthcoming videos such as the titles of the videos, actors and directors of the videos, content of the videos, etc.

Cable provider 14 compares the information of the forthcoming videos with the registered interest profile of subscriber 12. For each corresponding match between the forthcoming videos and the registered interest profile of subscriber 12, cable provider 14 generates a promotional email for subscriber 12. The email includes embedded links for the video titles matching the interest profile of subscriber 12. Cable provider 14 sends the email to subscriber 12 via Internet 16. Alternatively, cable provider 14 posts the email on cable provider website 52 for subscriber 12 to access when using Internet 16.

Upon receiving the email, subscriber 12 uses computer 20 to click on the link contained in the email in order to obtain more detailed information about the recommended video. The link references at least one of cable provider website 52 and the content provider website of the content provider providing the recommended video. If interested in viewing the recommended video, subscriber 12 uses computer 20 to transmit a request over Internet 16 to cable provider 14 (or to the content provider) requesting that the video be delivered to television 26 of subscriber 12. When the recommended video is available from the content provider, the content provider transfers a copy of the video to cable provider 14 in accordance with the delivery procedure described above with reference to VOD system 10. In turn, cable provider 14 delivers the video to television 26 via cable television network 18 for subscriber 12 to view in accordance with the delivery procedure described above with reference to VOD system 10.

This concept can be extended in that cable provider 14 could share the interest profile directly with any one of content providers 22 and 24. In this case, content providers 22 and 24 could originate their own promotional email for subscriber 12. Content providers 22 and 24 would electronically transfer any videos selected by subscriber 12 to cable provider 14 for delivery of the selected videos to television 26 via cable television network 18.

Furthermore, subscriber 12 may use computer 20 to register a profile of interest directly on a content provider website such as content provider website 28. In this case, cable provider website 52 would not be required for subscriber 12 to register a profile of interest and content provider 22 would compare videos available for delivery from the content provider to subscriber 12 with the registered interest profile. For each corresponding match between the available videos and the registered interest profile, content provider 22 transfers a promotional email to subscriber 12 via Internet 16. The promotional email contains a list of videos available from content provider 22 which correspond with the registered interest profile. Upon receiving the email, subscriber 12 uses computer 20 to transmit a request over Internet 16 to content provider 22 requesting that a selected video be delivered to television 26 of the subscriber. In turn, content provider 22 transfers the selected video to cable provider 14 which in turn delivers the selected video to television 26 via cable television network 14 for subscriber 12 to view in accordance with the delivery procedure described above with reference to VOD system 10.

Additionally, subscriber 12 may register a profile of interest directly with an entity such as a fan club 54 which may or may not have a website presence on Internet 16. Subscriber 12 registers the profile of interest with fan club 54 using telephone, mail, email, etc. Fan club 54 then communicates an email to subscriber 12 containing a list of videos which the fan club is aware of and which of is interest to members of the fan club. Fan club 54 also includes in the email a list of content providers such as content provider 22 which have the videos of interest. In turn, subscriber 12 responds to the email by using computer 20 to communicate to content provider 22 via Internet 16 that the subscriber is interested in viewing a video listed in the email. In response, content provider 22 transfers a copy of the selected video to cable provider 14. Cable provider 14 then delivers the selected video received from content provider 22 to television 26 via cable television network 14 for subscriber 12 to view in accordance with the delivery procedure described above with reference to VOD system 10.

Thus, it is apparent that there has been provided, in accordance with the present invention, a method and system which enables subscribers of a cable television service provider to select videos listed on third party content provider Internet websites using personal computers connected to the Internet for on-demand delivery of the selected videos from the third party content providers to subscriber televisions via a cable television network that fully satisfy the objects, aims, and advantages set forth above. While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

1. A video-on-demand system for use with personal computers connected to the Internet, the system comprising:
a cable television network;
content provider Internet websites which list videos available for delivery from third party content providers to subscribers of a cable television service provider, wherein the subscribers use the personal computers to select videos from the content provider websites for delivery to the subscribers; and
televisions associated with the subscribers and connected to the cable television service provider via the cable television network;
wherein the content providers and the cable television service provider are in communication with one another in order for the cable television service provider to receive the selected videos from the content providers;
wherein the cable television service provider delivers the selected videos to the televisions via the cable television network for the subscribers to view on the televisions.

2. The system of claim 1 wherein:
the cable television service provider delivers the selected videos by streaming the selected videos to the televisions via the cable television network immediately after the subscribers have selected the videos.

3. The system of claim 1 wherein:
the cable television service provider stores the selected videos on a video server for subsequent delivery from the video server to the televisions via the cable television network.

4. The system of claim 1 wherein:
the cable television service provider delivers the selected videos to video recorders associated with the televisions via the cable television network for the subscribers to subsequently view on the televisions.

5. The system of claim 1 wherein:
the subscribers perform key word searches using the personal computers in order to select videos from the content provider websites for delivery to the subscribers.

6. The system of claim 1 wherein:
the subscribers use the personal computers to browse categories listed in the content provider websites in order to select videos from the content provider websites for delivery to the subscribers.

7. The system of claim 1 wherein:
the subscribers provide identification to the content providers when selecting videos from the content providers;
wherein the content providers provide the identification along with the selected videos to the cable television service provider;
wherein the cable television service provider uses the identification in order to deliver the selected videos to the televisions via the cable television network.

8. The system of claim 1 wherein:
the content providers provide descriptive information identifying the selected videos along with the selected videos to the cable television service provider for use by the cable television service provider.

9. The system of claim 1 wherein:
the cable television service provider bills the subscribers for the selected videos on behalf of the content providers.

10. The system of claim 1 wherein:
the subscribers have subscriptions with the cable television service provider to select videos from the content provider websites for delivery to the subscribers, wherein the cable television service provider bills the subscribers for the subscriptions.

11. The system of claim 1 wherein:
the personal computers and the televisions are remote from one another and are in indirect communication with one another via the Internet and the cable television network.

12. The system of claim 1 further comprising:
a cable television service provider Internet website, wherein the subscribers use the personal computers to register video interest profiles on the cable television service provider website;
wherein the content providers communicate information to the cable television service provider regarding videos available for delivery from the content providers to the subscribers;
wherein the cable television service provider compares the information regarding the available videos with the video interest profiles;
wherein the cable television service provider sends emails to the subscribers containing information regarding the available videos which correspond to the video interest profiles.

13. The system of claim 12 wherein:
the subscribers use the personal computers to transmit delivery requests to the content providers via the Internet for videos identified in the emails;
wherein in response to the requests, the cable television service provider receives the requested videos from the content providers and then delivers the requested videos to the televisions via the cable television network for the subscribers to view on the televisions.

14. The system of claim 1 wherein:
the subscribers use the personal computers to register video interest profiles on the content provider websites;
wherein the content providers sends emails to the subscribers regarding videos which correspond to the video interest profiles and which are available for delivery from the content providers to the subscribers.

15. The system of claim 14 wherein:
the subscribers use the personal computers to transmit delivery requests to the content providers via the Internet for videos identified in the emails;
wherein in response to the requests, the cable television service provider receives the requested videos from the content providers and then delivers the requested videos to the televisions via the cable television network for the subscribers to view on the televisions.

16. A video-on-demand system for use with a personal computer connected to the Internet, the system comprising:
a cable television network;
a content provider Internet website, wherein the content provider website lists videos available for delivery from a third party content provider to a subscriber of a cable television service provider, wherein the subscriber uses the personal computer to select a video from the content provider website for delivery to the subscriber; and
a television associated with the subscriber and connected to the cable television service provider via the cable television network;
wherein the content provider and the cable television service provider are in communication with one another in order for the cable television service provider to receive the selected video from the content provider;
wherein the cable television service provider delivers the selected video to the television via the cable television network for the subscriber to view on the television.

17. The system of claim 16 wherein:
the cable television service provider delivers the selected video by streaming the selected video to the television via the cable television network immediately after the subscriber has selected the video.

18. The system of claim 16 wherein:
the cable television service provider stores the selected video on a video server for subsequent delivery from the video server to the television via the cable television network.

19. The system of claim 16 wherein:
the cable television service provider delivers the selected video to a video recorder associated with the television via the cable television network for the subscriber to subsequently view on the television.

20. The system of claim 16 wherein:
the subscriber performs a key word search using the personal computer in order to select a video from the content provider website for delivery to the subscriber.

21. The system of claim 16 wherein:
the subscriber uses the personal computer to browse categories listed in the content provider website in order to select a video from the content provider website for delivery to the subscriber.

22. The system of claim 16 wherein:
the content provider provides an identification identifying the subscriber along with the selected video to the cable television service provider;
wherein the cable television service provider uses the identification in order to deliver the selected video to the television via the cable television network.

23. The system of claim 16 wherein:
the content provider provides descriptive information identifying the selected video along with the selected video to the cable television service provider for use by the cable television service provider.

24. The system of claim 16 wherein:
the cable television service provider bills the subscriber for the selected video on behalf of the content provider.

25. The system of claim 16 wherein:
the subscriber has a subscription with the cable television service provider to select videos from the content provider website for delivery to the subscriber, wherein the cable television service provider bills the subscriber for the subscription.

26. The system of claim 16 wherein:
the personal computer and the television are remote from one another and are in indirect communication with one another via the Internet and the cable television network.

27. The system of claim 16 further comprising:
a cable television service provider Internet website, wherein the subscriber uses the personal computer to register a video interest profile on the cable television service provider website;
wherein the content provider communicates information to the cable television service provider regarding videos available for delivery from the content providers to the subscriber;
wherein the cable television service provider compares the information regarding the available videos with the video interest profile;
wherein the cable television service provider sends an email to the subscriber containing information regarding the available videos which correspond to the video interest profile.

28. The system of claim 27 wherein:
the subscriber uses the personal computer to transmit a delivery request to the content provider via the Internet for a video identified in the email;
wherein in response to the request, the cable television service provider receives the requested video from the content provider and then delivers the requested video to the television via the cable television network for the subscriber to view on the television.

29. The system of claim 16 wherein:
the subscriber uses the personal computer to register a video interest profile on the content provider website;
wherein the content provider sends an email to the subscriber via the Internet regarding videos which correspond to the video interest profile and which are available for delivery from the content provider to the subscriber.

30. The system of claim 29 wherein:
the subscriber uses the personal computer to transmit a delivery request to the content provider via the Internet for a video identified in the email;
wherein in response to the request, the cable television service provider receives the requested video from the content provider and then delivers the requested video to the television via the cable television network for the subscriber to view on the television.

31. A video-on-demand method for use with a personal computer connected to the Internet, and for use with a television associated with a subscriber of a cable television service provider and connected to a cable television service provider via a cable television network, the method comprising:
providing a content provider Internet website listing videos available for delivery from a third party content provider to a subscriber of the cable television service provider;
the subscriber using the personal computer to select a video from the content provider website for delivery to the subscriber;
communicating the selected video from the content provider to the cable television service provider; and
delivering the selected video from the cable television service provider to the television via the cable television network for the subscriber to view on the television.

32. The method of claim 31 wherein:
delivering the selected video includes streaming the selected video from the cable television service provider to the television via the cable television network immediately after the subscriber has selected the video.

33. The method of claim 31 further comprising:
storing the selected video on a video server of the cable television service provider for subsequent delivery;
wherein delivering the selected video includes subsequently delivering the selected video from the video server to the television via the cable television network.

34. The method of claim 31 wherein:
delivering the selected video includes delivering the selected video to a video recorder associated with the television via the cable television network for the subscriber to subsequently view on the television.

35. The method of claim 31 wherein:
the subscriber using the personal computer includes the subscriber performing a key word search using the personal computer in order to select a video from the content provider website for delivery to the subscriber.

36. The method of claim 31 wherein:
the subscriber using the personal computer includes the subscriber using the personal computer to browse categories listed in the content provider website in order to select videos from the content provider website for delivery to the subscriber.

37. The method of claim 31 wherein:
communicating the selected video from the content provider to the cable television service provider includes communicating an identification identifying the subscriber along with the selected video from the content provider to the cable television service provider;
wherein delivering the selected video includes using the identification in order to deliver the selected video to the television via the cable television network.

38. The method of claim 31 wherein:
the content provider provides descriptive information identifying the selected video along with the selected video to the cable television service provider for use by the cable television service provider.

39. The method of claim 31 further comprising:
the cable television service provider billing the subscriber for the selected video on behalf of the content provider.

40. The method of claim 31 further comprising:
the subscriber obtaining a subscription with the cable television service provider to select videos from the content provider website for delivery to the subscriber; and
the cable television service provider billing the subscriber for the subscription.

41. The method of claim 31 wherein:
the personal computer and the television are remote from one another and are in indirect communication with one another via the Internet and the cable television network.

42. The method of claim 31 further comprising:
providing a cable television service provider Internet website;
the subscriber using the personal computer to register a video interest profile on the cable television service provider website;
comparing information regarding videos available for delivery from the content provider to the subscriber with the video interest profile; and
transferring an email to the personal computer containing information regarding the videos which correspond to the video interest profile and which are available for delivery from the content provider to the subscriber.

43. The method of claim 42 further comprising:
the subscriber using the personal computer to transmit a delivery request to the content provider via the Internet for a video identified in the email;
in response to the request, communicating the requested video from the content provider to the cable television service provider, and then delivering the requested video from the cable television service provider to the television via the cable television network for the subscriber to view on the television.

44. The method of claim 31 further comprising:
the subscriber using the personal computer to register a video interest profile on the content provider website;
sending an email to the subscriber regarding videos which correspond to the video interest profile and which are available for delivery from the content provider to the subscriber.

45. The method of claim 44 further comprising:
the subscriber using the personal computer to transmit a delivery request to the content provider via the Internet for a video identified in the email;
in response to the request, communicating the requested video from the content provider to the cable television service provider, and then delivering the requested video from the cable television service provider to the television via the cable television network for the subscriber to view on the television.

46. A video-on-demand system for use with a personal computer connected to the Internet, the system comprising:
a cable television service provider having a cable television network connected to a television of a subscriber;
an Internet website, wherein the subscriber uses the personal computer to register a video interest profile on the website; and
a third party content provider which provides information regarding videos available for delivery from the content provider to the television of the subscriber via the cable television network;
wherein at least one of the cable television service provider and the content provider compares the information regarding the available videos with the video interest profile and then sends an email to the subscriber via the Internet, the email containing information regarding the available videos which correspond to the video interest profile.

47. The system of claim 46 wherein:
the subscriber uses the personal computer to transmit a delivery request to at least one of the cable television service provider and the content provider via the Internet for a video identified in the email;
wherein in response to the request, the cable television service provider receives the requested video from the content provider and then delivers the requested video to the television via the cable television network for the subscriber to view on the television.

48. The system of claim 46 wherein:
the website is the Internet website of the content provider.

49. The system of claim 46 wherein:
the website is the Internet website of the cable television service provider.

50. The system of claim 46 further comprising:
the website lists videos available for delivery from the content provider to the subscriber, wherein the subscriber uses the personal computer to select a video from the for delivery from the content provider to the subscriber; and
wherein in response to the request, the cable television service provider receives the selected video from the content provider and then delivers the selected video to the television via the cable television network for the subscriber to view on the television.

51. A video-on-demand method for use with a personal computer connected to the Internet and for use with a cable television service provider having a cable television network connected to a television of a subscriber, the method comprising:
providing an Internet website;
the subscriber using the personal computer to register a video interest profile on the website;
providing information regarding videos available for delivery from a content provider to the television of the subscriber via the cable television network;
comparing information regarding the available videos with the video interest profile; and
sending an email to the subscriber via the Internet, the email containing information regarding the videos which correspond to the video interest profile.

52. The system of claim 51 further comprising:
the subscriber using the personal computer to transmit a delivery request to at least one of the cable television service provider and the content provider via the Internet for a video identified in the email;
in response to the request, transferring the requested video from the content provider to the cable television service provider, and then delivering the requested video to the television via the cable television network for the subscriber to view on the television.

53. The method of claim 52 wherein:
the website is the Internet website of the content provider.

54. The method of claim 52 wherein:
the website is the Internet website of the cable television service provider.

55. The system of claim 52 further comprising:
listing videos available for delivery from the content provider to the subscriber on the website;
the subscriber using the personal computer to select a video from the content provider website for delivery from the content provider to the subscriber;
communicating the selected video from the content provider to the cable television service provider; and
delivering the selected video to the television via the cable television network for the subscriber to view on the television.
